(19) United States
(12) Patent Application Publication
(10) Pub. No.: US 2017/0261325 A1
(43) Pub. Date: Sep. 14, 2017

(54) METHOD AND SYSTEM FOR ASCERTAINING THE POSE OF A VEHICLE

(71) Applicant: Robert Bosch GmbH, Stuttgart (DE)

(72) Inventors: Gernot Schroeder, Ludwigsburg (DE); Jan Rohde, Stuttgart (DE); Martin Mueller, Stuttgart - Bad Cannstatt (DE); Michael Pagel, Magstadt (DE); Philipp Lehner, Muehlacker (DE)

(21) Appl. No.: 15/442,981

(22) Filed: Feb. 27, 2017

(30) Foreign Application Priority Data
Mar. 8, 2016 (DE) 102016203723.4

(51) Int. Cl. G01C 21/28; G01C 21/04

(52) U.S. Cl. CPC G01C 21/28; G01C 21/04; G01S 19/13

(57) ABSTRACT

A method for ascertaining the pose of a vehicle is described, in which the vehicle ascertains its own position and/or spatial orientation with the aid of information from its environment. In the process, the vehicle ascertains supplementary information about dynamic objects in its environment with the aid of environment sensors and uses the ascertained supplementary information for ascertaining its own position and/or spatial orientation.

### CROSS REFERENCE

The present application claims the benefit under 35 U.S.C. §119 of German Patent Application No. DE 102016203723.4 filed on Mar. 8, 2016, which is expressly incorporated herein by reference in its entirety.

### FIELD

The present invention relates to a method for ascertaining the pose of a vehicle, in which the vehicle senses static objects and in addition also dynamic objects in its environment and uses them for determining its position and its spatial orientation.

Moreover, the present invention relates to a system for carrying out the method.

### BACKGROUND INFORMATION

Current driver-assistance systems (ADAS—Advanced Driver Assistance Systems) as well as highly automated vehicle systems for autonomous driving in city traffic (UAD=Urban Automated Driving) increasingly presuppose detailed knowledge of the environment of the vehicle as well as situational awareness. One important precondition for this is a need-based self-localization of the vehicle system. Only if this condition is met will it be possible, for example, to plan future driving applications with sufficient precision. A map-related localization, in which environment sensors installed in the vehicle monitor the vehicle environment and certain environmental information is extracted, is normally utilized for this purpose. The extracted environmental information is stored in a local environment model and then matched against a digital map with the aid of a suitable method. Depending on the extractable quantity and quality of environmental information, a specific localization accuracy is obtained in combination with odometer data. For this reason the localization accuracy of this method may vary considerably as a function of the situation.

### SUMMARY

It is an object of the present invention to improve the localization accuracy in the self-localization of a vehicle.

Advantageous specific embodiments of the present invention are described herein.

In accordance with the present invention, a method for ascertaining the pose of a vehicle is provided, in which the vehicle ascertains its own position and/or spatial orientation with the aid of information from its environment. In the process, the vehicle ascertains certain supplementary information about dynamic objects in its environment and uses the ascertained supplementary information for determining its own position and/or spatial orientation. The detection of dynamic objects increases the quantity of the environmental information available for ascertaining the pose of the vehicle and thereby allows for a considerable improvement in the localization result. As an alternative, the demands placed on the employed environmental sensor system are able to be reduced, which goes hand in hand with lower production costs. The robustness of the vehicle localization is enhanced at the same time because information from different sources is used.

In one specific embodiment, it is provided that the vehicle ascertains the relative position, the relative spatial orientation and/or the trajectory of dynamic objects in its environment as supplementary information and uses it for ascertaining its own position and/or spatial orientation. On the basis of this information it is possible to infer the location and course of the road and other routes, which can subsequently be compared with the corresponding roads and routes on the digital map. The position of a dynamic object is preferably acquired with the aid of the already installed environment sensors, which means that the quantity of the extractable environmental information may be increased without additional expense and the localization accuracy is improved as a result.

In one further specific embodiment, the vehicle carries out a self-localization by ascertaining certain environmental information pertaining to static objects in its environment with the aid of the environment sensors, by generating a local environment model with the aid of the ascertained environmental information, and by subsequently comparing the local environment model with a digital map in order to determine its own position and/or orientation on the digital map. The use of environmental information both of static and dynamic objects allows for a vehicle localization that is based solely on observation and which furthermore has better robustness because information from various sources is utilized.

In one further specific embodiment, the vehicle uses the supplementary information to generate additional data points in the local environment model, which are then compared with corresponding points on the digital map. This method constitutes a method that is particularly suitable for calculating the vehicle pose.

In one further specific embodiment, it is provided that the vehicle uses the ascertained supplementary information for ascertaining its orientation in its own traffic lane. This measure makes it particularly easy to improve the knowledge of the vehicle orientation with reference to the road on which the driving takes place, and therefore is also able to improve the localization based on the odometer data.

In one further specific embodiment, it is provided that the vehicle detects the orientation of an oncoming other vehicle traveling in an opposite lane in relation to itself as an item of supplementary information, and uses the detected orientation of the other vehicle for estimating its orientation in its own traffic lane. Since oncoming traffic passes in relatively close proximity to the vehicle, other vehicles in the opposing traffic lane are particularly suitable for ascertaining the ego vehicle's own orientation.

In one further specific embodiment, it is provided that the vehicle ascertains the relative position, the relative spatial orientation and/or the trajectory of other vehicles in its own traffic lane, in an adjacent traffic lane or on an adjacent road as supplementary information and uses the ascertained supplementary information for ascertaining its own position and/or spatial orientation. In principle, it is possible to increase the accuracy and robustness of the localization by using all vehicles that are detectable with the aid of available environment sensors.

In one further specific embodiment, it is provided that the vehicle ascertains not only the position and/or the trajectory of a dynamic object as supplementary information but also the type of object of the dynamic object. In the process, the vehicle compares the ascertained position and/or trajectory of the dynamic object with a possible current location and/or route assigned to this type of object on the digital map. Ascertaining the object type makes it possible to draw conclusions about the location of the respective object or of the route driven or traversed on foot by the respective object. This allows for less complicated matching between the local environment model and the digital map, because the number of potential locations on the digital map is able to be reduced considerably when the object type is taken into account.

In one further specific embodiment, it is provided that the vehicle ascertains the relative position, the relative spatial orientation and/or the trajectory of a pedestrian as supplementary information and compares the acquired supplementary information with a sidewalk or pedestrian crossing shown on the digital map. The use of pedestrians as dynamic objects makes it possible to increase the amount of extractable environmental information and thus to enhance the localization accuracy.

Below, the present invention is explained in greater detail with the aid of the figures.

### BRIEF DESCRIPTION OF THE DRAWINGS

FIG. 1 shows schematically, a vehicle that includes a plurality of environment sensors and a control unit for self-localization of the vehicle.

FIG. 2 shows schematically, a first traffic situation, in which the vehicle detects static objects in its environment with the aid of the vehicle sensor system.

FIG. 3 shows a schematic representation to illustrate the matching between the local environment model of the situation from FIG. 2 and a digital map.

FIG. 4 shows schematically, a further traffic situation, in which the vehicle detects the positions, orientations and trajectories of dynamic objects in its environment.

FIG. 5 shows schematically, a further traffic situation, in which the vehicle detects another vehicle on an adjacent road.

FIG. 6 shows schematically, a traffic situation, in which the vehicle detects pedestrians and stationary other vehicles.

### DETAILED DESCRIPTION OF EXAMPLE EMBODIMENTS

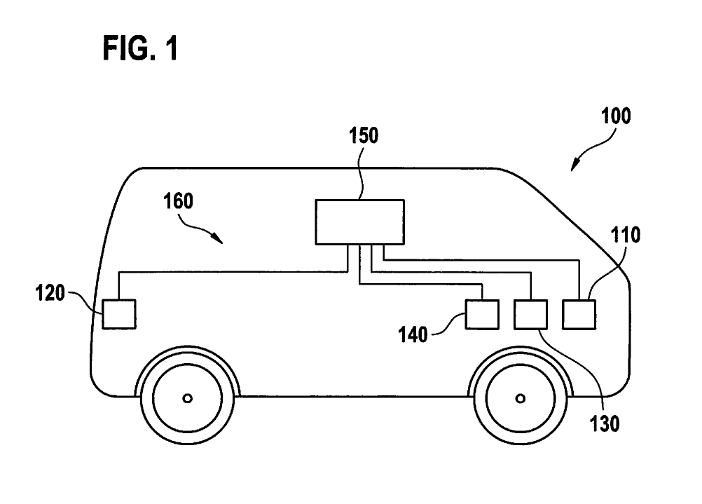

FIG. 1 shows a vehicle 100 according to the present invention which is equipped with a system 160 for the precise ascertainment of the vehicle pose. A pose or spatial position describes the combination of position and spatial orientation or alignment of an object. System 160 includes a plurality of environment sensors 110, 120, 130 for detecting the vehicle environment as well as a control unit 150 for ascertaining the vehicle pose on the basis of the acquired environmental information. In the following example, vehicle 100 has a total of three environment sensors 110, 120, 130, which may be realized in the form of a video camera, a radar sensor, a lidar sensor or an acoustic sensor, for example. Environment sensors 110, 120, 130 may be situated at any suitable location in the vehicle, such as in the front region, the rear region or an a side of the vehicle. Both the sensor type and the number and placement of the sensors on the vehicle are able to be adapted to the respective use. In addition, system 160 may include at least one further sensor 140, which, for example, may be embodied in the form of a satellite receiver for the satellite-based navigation. Moreover, control unit 150 may be equipped with an arithmetic unit for analyzing the sensor signals and for calculating the vehicle's pose, as well as a memory unit for storing a digital map (not shown here).

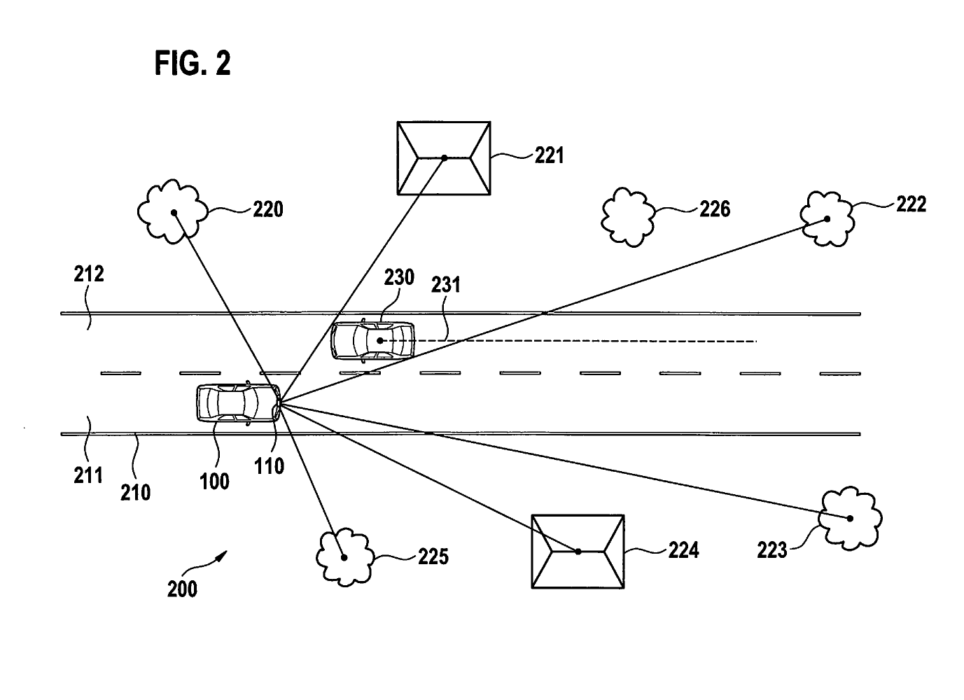

FIG. 2 schematically illustrates a possible traffic situation, in which vehicle 100 is traveling on a two-lane road 210. Multiple static objects 220 through 226 are located along road 210, which may be trees, buildings and other structures, for instance. In the example at hand, there is also another vehicle 230 in oncoming lane 212 of two-lane road 210. As indicated by lines in FIG. 2, ego vehicle 100 detects static objects 220 through 225 with the aid of one or more of its environment sensor(s) 110, 120 and extracts certain environmental information with regard to these static objects in the process.

For example, this is the relative position of these objects, their spatial orientation or distance. In addition, the object type is able to be ascertained as well, or the static objects can be identified with the aid of certain features. The environmental information extracted in the process is stored in a local environment model, which is matched with a digital map in order to ascertain the global position and the orientation of the vehicle on the digital map. The localization accuracy of this method essentially depends on the quantity and quality of environmental information extracted on the basis of static objects 220 through 225. Depending on the respective situation and the employed measuring method, the quantity and quality of extractable environmental information may vary to a considerable extent. For example, adverse weather conditions as well as other road users may obscure the view of static objects that are usable as landmarks. For example, this is the case with static object 226 in FIG. 2, which is hidden from the view of measuring environment sensor 110 on ego vehicle 100 on account of other vehicle 230. In order to improve the accuracy of the landmark-based localization method, the number of data points for the matching between the local environment model and the digital map is increased. This is by the additional consideration of dynamic objects and the supplementary information that is able to be extracted therefrom.

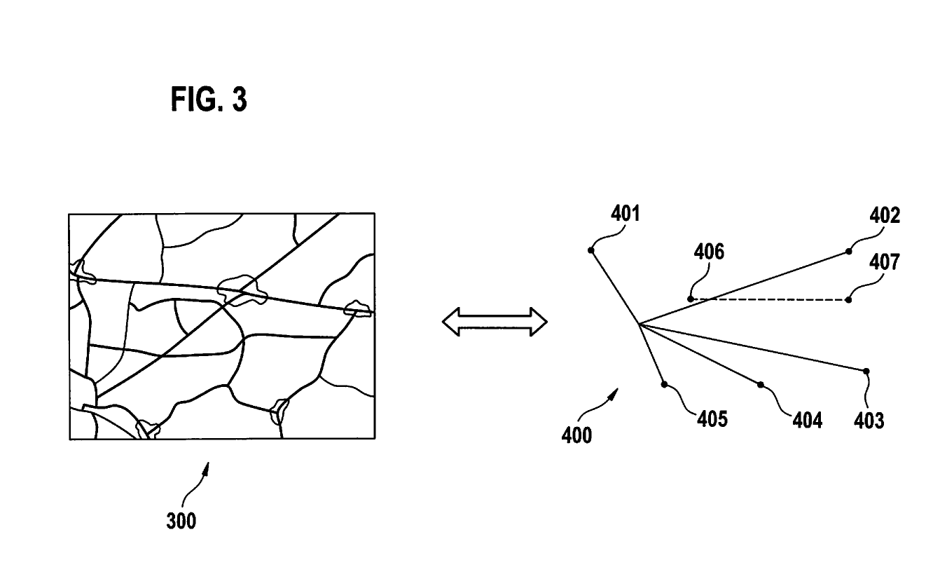

FIG. 3 illustrates the matching method between the local environment model of ego vehicle 100 from FIG. 2 and a digital map. It is clear that local environment model 400 includes as data points the positions of static objects 220 through 225 in relation to ego vehicle 100, static objects 220 through 225 having been detected by the environment sensor system. These data points form landmarks that are compared with corresponding landmarks on digital map 300 during the matching process. In case of a successful match, the data points of local environment model 400 are allocated to corresponding landmarks on the digital map and the position and orientation of the vehicle on the digital map is calculated by geometrical calculations. The actual matching may basically be carried out using any suitable method, for instance using the least square minimizing method.

As shown in FIG. 3, in addition to data points 401 through 405 generated by measurements on the static objects, local environment model 400 also includes two data points 406, 407, which result from measurements on other vehicle 230 from FIG. 2. These are the relative position of other vehicle 230 in relation to ego vehicle 100 as well as measured trajectory 231 of other vehicle 230 from FIG. 2. In this way it can be inferred from the position of another vehicle, detected by the environment sensor system of the ego vehicle, that the current location of the other vehicle is a road or traffic lane. In addition, the course of the particular road section is able to be inferred from the measured trajectory of the other vehicle.

Conclusions with regard to the course of the road or the traffic lane at the current location of the other vehicle can also be drawn on the basis of the measured orientation of the other vehicle. These conclusions may be used as additional data points 406, 407 for the matching between local environment model 400 and digital map 300. Since road users also exhibit unpredictable behavior in some instances, the information obtained from monitoring the position, orientation and trajectory of the dynamic objects may also include an error. Suitable measures may be implemented in the vehicle to prevent any negative effect of such erroneous information on the localization result. For example, a suitable plausibilization method is one of those measures. Here, the measured or ascertained information is checked for plausibility and only information having sufficient plausibility is used for the localization. It is also possible to allocate individual weighting factors to additional data points 406, 407 ascertained from measuring dynamic objects in local environment model 400, these weighting factors taking the respective probability into account that detected dynamic object is indeed present at a location it had been allocated. In this way only a low weighting factor may be assigned by the system to another vehicle that exhibits unusual behavior, for instance because it is driving beyond a paved road, the low weighting factor ensuring that data points ascertained by monitoring this vehicle will not or only negligibly be considered during the matching with digital map 300.

Apart from improving the self-localization by matching the local environment model with the digital map, the supplementary information such as position, orientation and trajectory ascertained through measurements of the dynamic objects may furthermore by used by the vehicle to improve the estimation of its own orientation within the traffic lane. Using exemplary traffic situations, the following text describes different options with regard to the manner in which the ego vehicle, by monitoring dynamic objects in its environment, is able to use supplementary information in order to improve the self-localization.

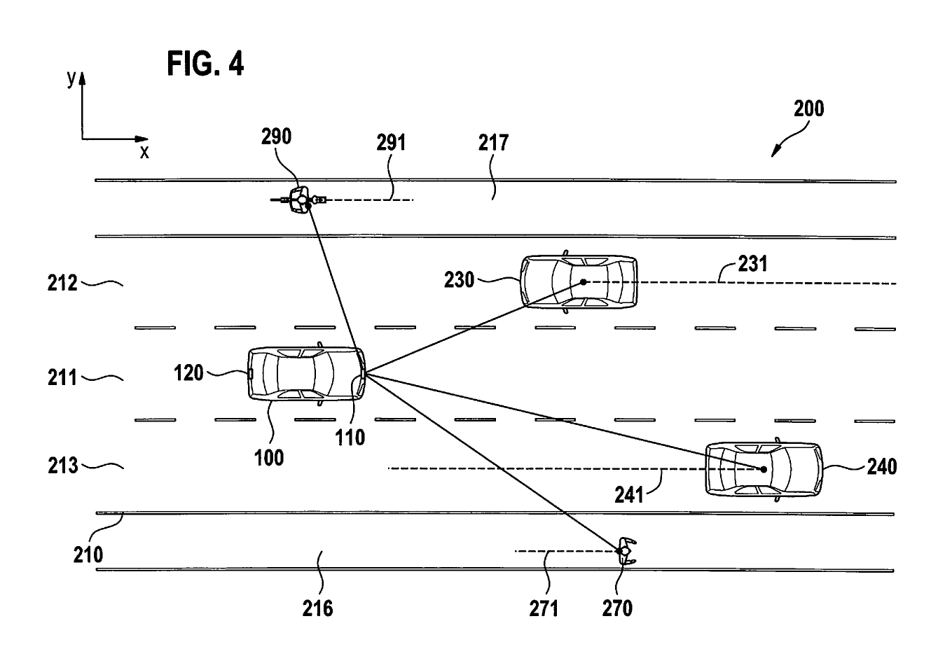

By way of example, FIG. 4 shows ego vehicle 100, which is traveling in a center traffic lane 211 of a three-lane road 210 and detects different road users 230, 240, 270, 290 as dynamic objects in its environment 200 with the aid of one or more of its environment sensor(s) 110, 120. In addition to the relative position of road users 230, 240, 270, 290 with regard to ego vehicle 100, their spatial orientations and trajectories 231, 241, 271, 291 are detected as well. Furthermore, it may also be the case that further supplementary information is acquired for each road user and used for improving the localization. Among such supplementary information are, for example, the speed or the object type of the respective road user. By analyzing the extracted environmental information, ego vehicle 100 is able to make an individual decision for each dynamic object 230, 240, 270, 290 as to the extent to which the respective supplementary information will be used for the self-localization. Depending on the application, different relevance may be allocated to the various road users, and their supplementary information, weighted by an individual weighting factor, may be taken into consideration when calculating the vehicle pose.

As can be gathered from FIG. 4, various types of dynamic objects may in principle be considered to improve the localization accuracy of ego vehicle 100. In addition to road vehicles, special vehicles such as a bus, railroad or streetcar, two-wheelers and pedestrians, among others, are suitable as dynamic objects. In the exemplary embodiment at hand, ego vehicle 100 detects the positions and trajectory 231, 241, 271, 291 of a first other vehicle 230 driving in an oncoming traffic lane 212, a second other vehicle 240 driving in an adjacent traffic lane in the driving direction of ego vehicle 100, a pedestrian 270 walking on a sidewalk 216, and a bicyclist 290 riding in a separate bicycle lane 217. However, since pedestrians and bicyclists may frequently also be encountered outside their assigned locations, the relevance of the supplementary information extracted from monitoring these road users may be correspondingly reduced in the self-localization of ego vehicle 100, depending on the situation and application case.

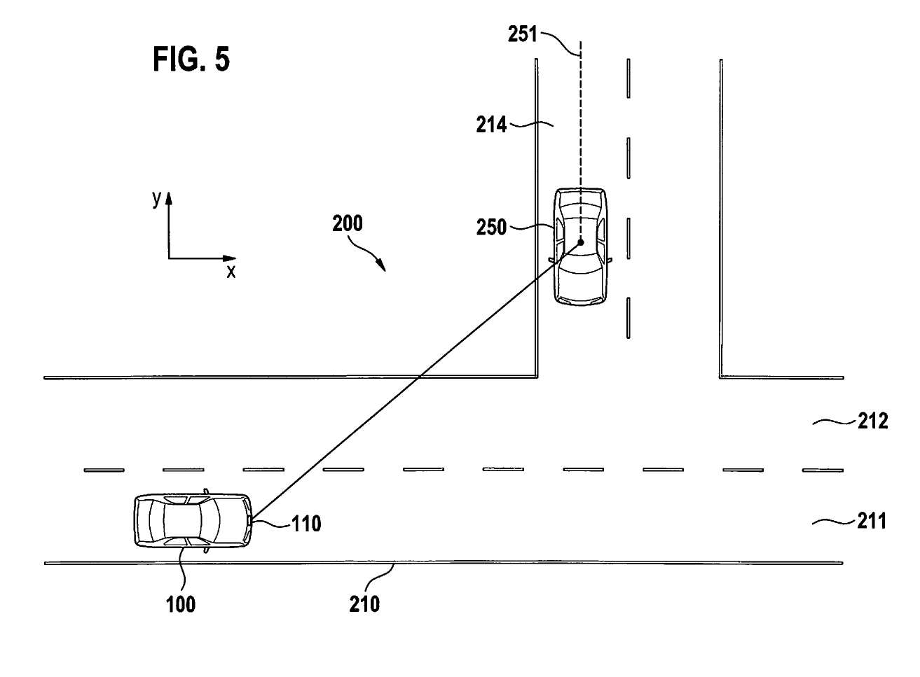

When selecting suitable dynamic objects, it is in principle also possible to take road users into account who are located on a road other than road 210 on which ego vehicle 100 is traveling. FIG. 5 shows such a traffic situation by way of example, in which ego vehicle 100 detects the position, orientation and trajectory 251 of another vehicle 250 traveling on a cross street 214 that intersects with road 210. Based on the position, orientation and trajectory 215 of other vehicle 250, it is possible to draw conclusions with regard to the existence and the course of cross street 214.

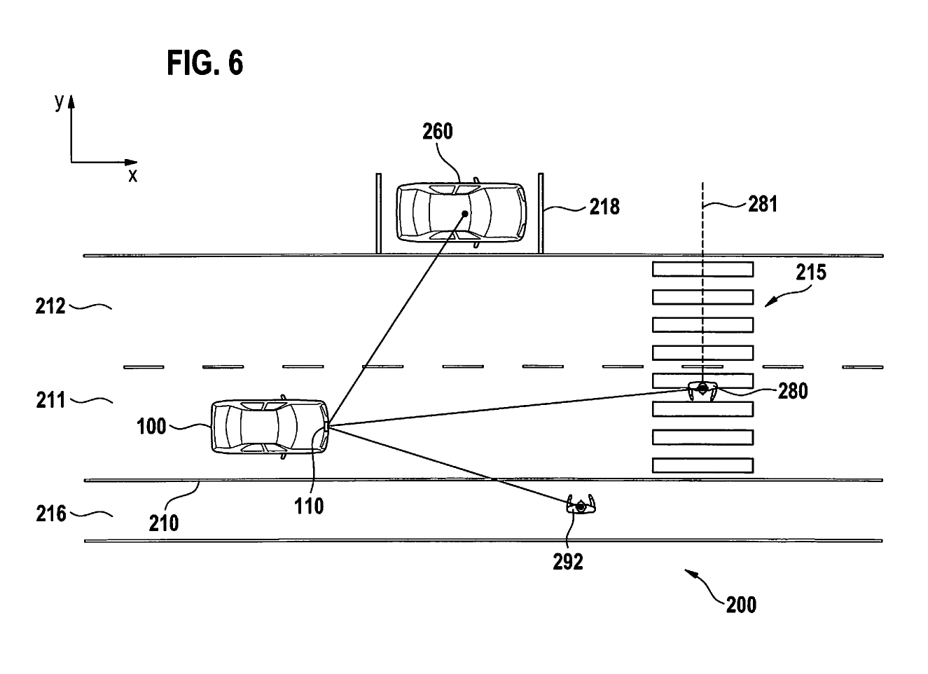

Additional supplementary information is able to be extracted by ascertaining the object type of a detected dynamic object. For example, while monitoring an object of the pedestrian type and by detecting his or her trajectory, it is possible to determine with a high degree of certainty that the pedestrian is ambulating on a sidewalk or a pedestrian crossing. It can therefore be stated with a high degree of probability that a sidewalk or pedestrian crossing extends along the monitored trajectory. In this context, FIG. 6 shows an exemplary traffic situation, in which ego vehicle 100 is monitoring a pedestrian 280 while said pedestrian is crossing road 210. Even without directly monitoring the pedestrian crossing, ego vehicle 100 may thus assume with a certain degree of probability that the position and trajectory 281 of pedestrian 280 matches the position and the course of pedestrian crossing 215.

Since in road traffic, road users of different object types usually stay in the areas or paths they are assigned, stationary dynamic objects may basically also be used for the self-localization. For example, ego vehicle 100, as shown in FIG. 6, while monitoring pedestrian 292 stopped at the edge of the road may come to the conclusion that a sidewalk is situated at the position of this pedestrian. In addition, by monitoring a parked other vehicle 260, ego vehicle 100 may conclude that a parking space is most likely located at the position of this vehicle. As a result, even in the case of non-moving road users and possibly after appropriate validation, the monitored position of the respective road user may be utilized as an additional data point for matching local environment model 400 with digital map 300.

The method of the present invention uses additional information in order to improve the localization result of current localization methods or to reduce the demands placed on the employed environment sensor system. The system according to the present invention utilizes poses and trajectories of other road users to improve the ego vehicle's own pose estimate. In so doing, for example, the orientation of oncoming vehicles in relation to the ego vehicle is measured and the estimate of the orientation in the ego vehicle's own lane is improved thereby. The matching of trajectories of other vehicles with the localization map may furthermore be used to advantageously influence also the global pose estimate. At the same time, the robustness of the localization system is improved inasmuch as information from different sources is used.

Although the present invention has been described predominantly on the basis of specific exemplary embodiments, it is by no means restricted to such. The expert will thus be able to suitably modify the described features and combine them with each other without departing from the core of the present invention. In particular, in addition to the road users already mentioned in the description, the position, orientation and trajectory of any suitable dynamic object in the environment of the ego vehicle may in principle be used to improve the self-localization. In addition, the method according to the present invention is not restricted to the self-localization of the ego vehicle with the aid of static objects. Any suitable method or any combination of methods is basically possible for the self-localization.

What is claimed is:

1. A method for ascertaining the pose of a vehicle, comprising:
ascertaining, by the vehicle, at least one of a position of the vehicle, and a spatial orientation of the vehicle, using information from an environment of the vehicle;
ascertaining, by the vehicle, supplementary information about dynamic objects in the environment of the vehicle, with the aid of environment sensors; and
using, by the vehicle, the ascertained supplementary information for ascertaining the at least one of the position of the vehicle, and the spatial orientation of the vehicle.

2. The method as recited in claim 1, wherein the vehicle ascertains as supplementary information at least one of: a relative position, a relative spatial orientation, and a trajectory, of the dynamic objects, and uses it for the at least one of the position of the vehicle, and the spatial orientation of the vehicle.

3. The method as recited in claim 1, wherein the vehicle carries out self-localization by ascertaining certain environmental information about static objects in the environment of the vehicle, with the aid of the environment sensors, by generating a local environment model with the aid of the ascertained environmental information and by then comparing the local environment model with a digital map to ascertain at least one of the position of the vehicle, an orientation of the vehicle, on the digital map.

4. The method as recited in claim 3, wherein the vehicle generates additional data points in the local environment model with the aid of the supplementary information, which are subsequently compared with corresponding points on the digital map.

5. The method as recited in claim 1, wherein the vehicle uses the ascertained supplementary information for ascertaining the orientation of the vehicle in its own traffic lane.

6. The method as recited in claim 5, wherein the vehicle detects as an item of supplementary information the orientation of another vehicle driving toward it in an oncoming traffic lane in relation to itself and uses the detected orientation of the other vehicle for estimating its orientation in its own traffic lane.

7. The method as recited in claim 1, wherein the vehicle ascertains, as an item of the supplementary information, at least one of a relative position, a relative spatial orientation, and a trajectory, other vehicles one of in its own traffic lane, in an adjacent traffic lane, or on an adjacent road, and wherein the vehicle uses the item of supplementary information for ascertaining the at least one of the position of the vehicle, and the spatial orientation of the vehicle.

8. The method as recited in claim 2, wherein the vehicle further ascertains, as supplementary information, an object type of the dynamic object, and the vehicle compares at least one of the ascertained position of the dynamic object and the trajectory of the dynamic object with at least one of a potential current location, and a potential route, allocated to the object type on the digital map.

9. The method as recited in claim 3, wherein the vehicle ascertains as supplementary information at least one of a relative position, a relative spatial orientation, and a trajectory of a pedestrian, and compares the acquired supplementary information with a sidewalk or pedestrian crossing shown on the digital map.

10. A system for a vehicle to ascertain the pose of the vehicle, the system designed to ascertain at least one of a position of the vehicle, and a spatial orientation of the vehicle, using information from an environment of the vehicle, ascertain supplementary information about dynamic objects in the environment of the vehicle, with the aid of environment sensors, and use the ascertained supplementary information for ascertaining the at least one of the position of the vehicle, and the spatial orientation of the vehicle.
